(19) United States
(12) Patent Application Publication
(10) Pub. No.: US 2002/0188867 A1
(43) Pub. Date: Dec. 12, 2002

(54) System and method for appliance adaptation and evolution

(76) Inventors: Robert D. Bushey, Fort Collins, CO (US); Gary Don Carlton, Greeley, CO (US)

Correspondence Address: HEWLETT-PACKARD COMPANY, Intellectual Property Administration, P.O. Box 272400, Fort Collins, CO, 80527-2400, US

(21) Appl. No.: 09/877,522

(22) Filed: Jun. 8, 2001

(51) Int. Cl. H04L 9/00

(52) U.S. Cl. 713/201

(57) ABSTRACT

The present disclosure relates to an appliance configured for connection to a network and communication with a device connected to the network. In one embodiment, the appliance comprises a processing device configured to control operation of the appliance, memory including logic configured to receive software that facilitates communication between the appliance and the device from a software source, and network interface devices with which the appliance communicates with the software source.

### FIELD OF THE INVENTION

The present disclosure relates to a system and method for appliance adaptation and evolution. More particularly, the disclosure relates to devices that receive software and/or firmware useful for accessing other devices via a network.

### BACKGROUND OF THE INVENTION

Presently, peripheral devices are used in conjunction with computing devices such as personal computers (PCs) in host-slave arrangements. In that the language spoken by the PC internally is normally different from that spoken by the peripheral device, the PC typically must include some means for translating communications from the peripheral device so that the PC and peripheral device can communicate with each other. Typically, these means include a peripheral driver that comprises software that is downloaded to the PC prior to use of the peripheral device.

Appropriate driver software is usually provided along with the peripheral device when it is sold. For instance, the peripheral device may be accompanied by a CDROM that contains the driver software along with a suite of software applications that the user may wish to use. Although viable, this arrangement has several disadvantages. First, having to download and configure a driver or other software is inconvenient for the user. Moreover, where the user is not especially computer-savvy, the prospect of downloading and configuring such software can even be daunting to the user. In addition to these problems, as glitches associated with the driver are discovered, the user may need to download and configure updated versions of the driver to his or her PC. To do this, the user may need to either wait for a new CDROM to arrive in the mail or, where the user's PC is Internet-enabled, download the driver from a web site of the peripheral device vendor. In the later case, more inconvenience is imposed upon the user in that the user will need to locate the correct download from the web site and, once it is found, download it from the Internet and initialize it on the PC.

Recently, various direct-connect devices have been introduced in the market that are not dependent upon a PC. Due to their self-sufficiency, such devices are often designated as “appliances.” These appliances typically are Internet-enabled and often are capable of peer-to-peer communications with other appliances. Many in the art currently envision a future in which such appliances will be used in a home or office environment with each of the appliances interconnected by a local area network (LAN). In such an arrangement, the appliances can “talk” with each other and transmit data back and forth therebetween.

As in the PC context, some form of driver software (or firmware) is needed in the appliance networking scenario to enable communications between the appliances. For example, if an image is captured with an image capture appliance (e.g., digital camera) and the user wishes to display the image on a another appliance such as a personal digital assistant (PDA), the image capture appliance will need some form of driver software and/or firmware adapted for accessing the PDA. As in the PC scenario, initial download, configuration, and later upgrade of this software and/or firmware is inconvenient to the user.

### SUMMARY OF THE INVENTION

From the foregoing, it can be appreciated that it would be desirable to have a system and method in which software and/or firmware can be downloaded and updated without inconvenience to the user.

The present disclosure relates to an appliance configured for connection to a network and communication with a device connected to the network. In one embodiment, the appliance comprises a processing device configured to control operation of the appliance, memory including logic configured to receive software that facilitates communication between the appliance and the device from a software source, and network interface devices with which the appliance communicates with the software source.

The disclosure further relates to a method for enabling communications between an appliance and a separate device. The method comprises the steps of automatically receiving software with the appliance that facilitates communication between the appliance and the separate device, and storing the software in memory of the appliance such that the appliance is adapted to communicate with the separate device.

The features and advantages of the invention will become apparent upon reading the following specification, when taken in conjunction with the accompanying drawings.

### BRIEF DESCRIPTION OF THE DRAWINGS

The invention can be better understood with reference to the following drawings. The components in the drawings are not necessarily to scale, emphasis instead being placed upon clearly illustrating the principles of the present invention.

FIG. 1 is a schematic view of a system for appliance adaptation and evolution.

FIG. 2 is a schematic view of an image capture appliance shown in FIG. 1.

FIG. 3 is a schematic view of a network storage device shown in FIG. 1.

FIG. 4 is a flow diagram that illustrates a first mode of operation of a software acquisition module shown in FIG. 2.

FIG. 5 is a flow diagram that illustrates a second mode of operation of the software acquisition module shown in FIG. 2.

FIG. 6 is a flow diagram that illustrates a second mode of operation of the software acquisition module shown in FIG. 2.

FIG. 7 is a flow diagram that illustrates operation of a software acquisition module shown in FIG. 3.

### DETAILED DESCRIPTION

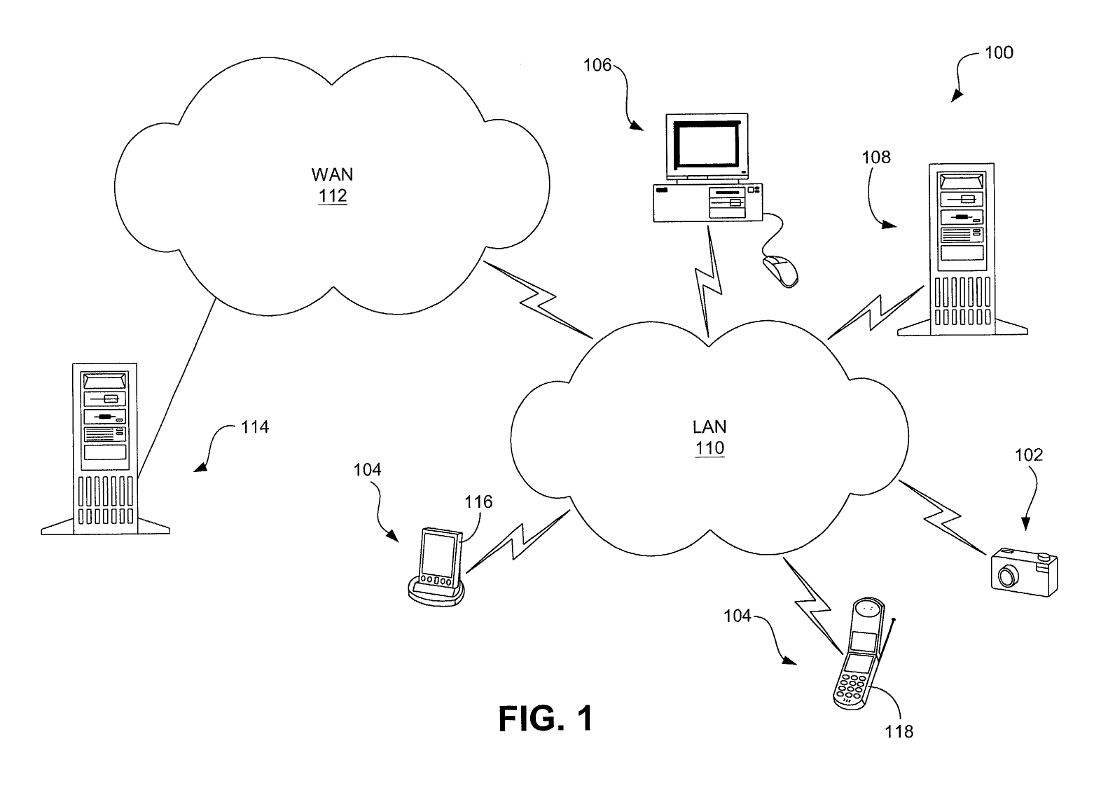

Referring now in more detail to the drawings, in which like numerals indicate corresponding parts throughout the several views, FIG. 1 illustrates a system 100 for appliance adaptation and evolution, and through which various software can be acquired. As used herein, the term “software” designates software and/or firmware as the case warrants. It is to be appreciated that this notation is used for purposes of simplicity only, however, and that it is not intended to limit the scope of the invention through use of the term “software” alone.

As indicated in FIG. 1, the system 100 can comprise an image capture appliance 102, various direct-connect appliances 104, a computing device 106, and a network storage device 108. Each of these components is connected to a local area network (LAN) 110. By way of example, the LAN 110 can comprise a home or office network in which connections are made through actual, physical connections, optical networking, or wirelessly. In the former case, connectivity may be facilitated through a hard-wired network using a common protocol such as Ethernet, or through a shared system such as a telephone and/or powerline network. In the wireless context, connectivity may be facilitated with a common wireless networking protocol such as Bluetooth™ from Bluetooth SIG™ or 802.11 protocol from the Institute of Electrical and Electronics Engineers (IEEE). As will be appreciated from the discussion that follows, the precise configuration and protocol used to form the LAN 110 are not critical. More important is that the LAN 110 is configured to facilitate communications between the various components noted above that are connected to the LAN.

In communication with the LAN 110 is a wide area network (WAN) 112 that typically comprises the Internet. Connected to the WAN 112 (typically through an actual, physical connection) is a web server 114 that can store various software that, as discussed below, can be shared with the image capture appliance 102 as needed. Although only one such server 114 is shown, it will be understood that this web server is representative of the many web servers accessible over the WAN 112.

As its name suggests, the image capture appliance 102 is configured for capturing images. Accordingly, the image capture appliance 102 can comprise a digital camera. Alternatively, the appliance 102 can comprise any other image capture device, such as a scanner. Although an image capture appliance is specifically discussed herein, persons having ordinary skill in the art will appreciate that the teachings provided herein apply equally to other electrical devices. In a preferred arrangement, the image capture appliance 102 is configured to capture both still and video images. Where the appliance 102 is configured to capture video, the appliance typically further is configured to capture audio. Accordingly, in a preferred arrangement, the image capture appliance 102 is arranged as a multimedia image capture appliance. The image capture appliance 102 can include other features such as a document capture mode in which the appliance can recognize characters with an optical character recognition (OCR) functionality. Irrespective of its specific functionalities, however, the image capture appliance 102 is adapted to communicate with the other components connected to the LAN 110. For instance, the image capture appliance 102 can communicate with the direct-connect appliances 104 and the computing device 106 in a peer-to-peer arrangement.

The direct-connect appliances 104 can comprise a variety of devices that are capable of direct connection to a network such as LAN 110. As indicated in FIG. 1, the direct connect appliances 104 can, for example, comprise a personal digital assistant (PDA) 116 and a digital mobile phone 118. Although these devices are identified for purposes of example, it will be appreciated the direct-connect appliances can comprise other devices that are capable of direct connection to a network and which may be used in concert with the image capture appliance 102. As shown in FIG. 1, the computing device 106 can comprise a personal computer (PC), such as a desktop PC. The network storage device 108 can comprise a server that includes storage memory in which, as is discussed below, various software can be stored and transmitted to the image capture appliance 102 as needed.

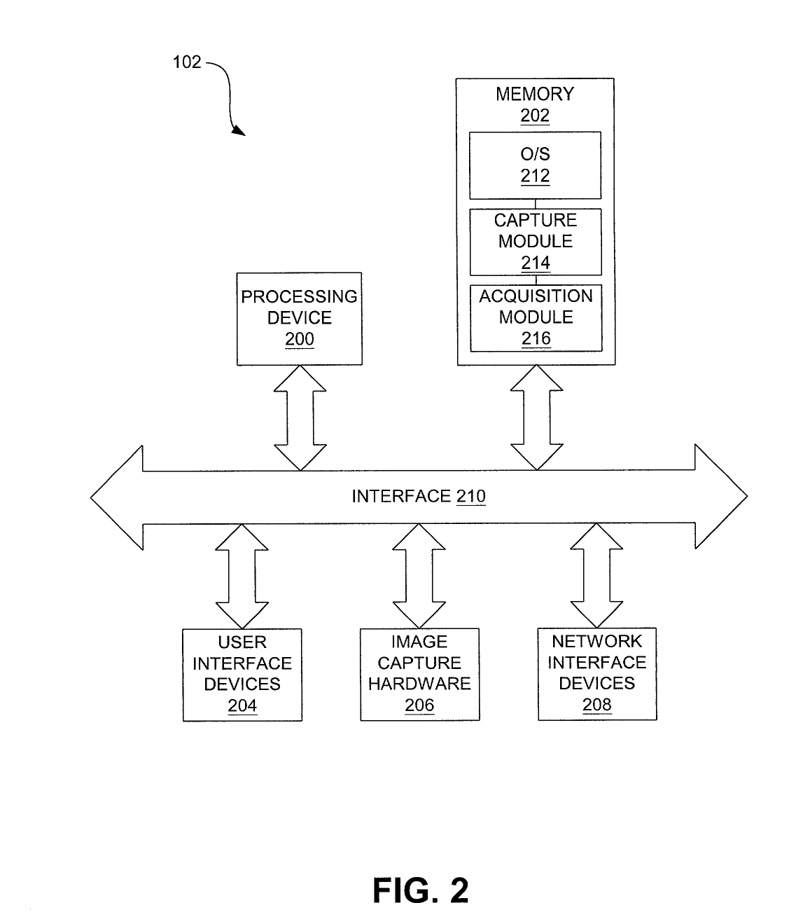

FIG. 2 is a schematic view illustrating an example architecture for the image capture appliance 102 shown in FIG. 1. As indicated in FIG. 2, the image capture appliance 102 typically comprises a processing device 200, memory 202, user interface devices 204, image capture hardware 206, network interface devices 208, and an interface 210 to which each of the other components electrically connects. The processing device 200 is adapted to execute commands stored in memory 202 and can comprise a general-purpose processor, a microprocessor, one or more application-specific integrated circuits (ASICs), a plurality of suitably configured digital logic gates, and other well known electrical configurations comprised of discrete elements both individually and in various combinations to coordinate the overall operation of the image capture appliance 102. The user interface devices 204 typically comprise interface tools with which the appliance settings can be changed and through which the user can communicate commands to the image capture appliance 102. By way of example, the user interface devices 204 can comprise one or more function keys with which the operation of the image capture appliance 102 can be controlled.

The image capture hardware 206 comprises the components used to form and store image data. By way of example, the image capture hardware 206 comprises a lens, one or more focusing elements (lenses, mirrors, etc.), one or more light sources, one or more light sensing elements (e.g., charge-coupled device (CCD)), and so forth. The network interface devices 208 are adapted to facilitate communications across the LAN 110 as well as the WAN (e.g., Internet) and therefore can comprise a data transmitting/receiving device. As identified above, connection to the LAN 110 can be through actual, physical connection or through wireless connection. Accordingly, the particular nature of the network interface devices 208 depends upon the particular networking scheme used for the LAN 110. As is discussed below, the network interface devices 216 are adapted to receive and/or retrieve software that is used to communicate with and/or control other devices such as the direct-connect appliances 104 and the computing device 106.

The memory 202 includes an operating system 212, a capture module 214, and a software acquisition module 216. The operating system 212 contains the various commands used to control the general operation of the image capture appliance 102. The capture module 214 comprises software that is adapted to, in conjunction with the image capture hardware 206, capture image data that can be displayed by the image capture appliance 102 and/or transmitted to another device for viewing or other manipulation. The acquisition module 216 comprises software that, as is described in detail below, is adapted to retrieve software used to communicate with and/or control other devices such as the direct connect appliances 104 and the computing device 106.

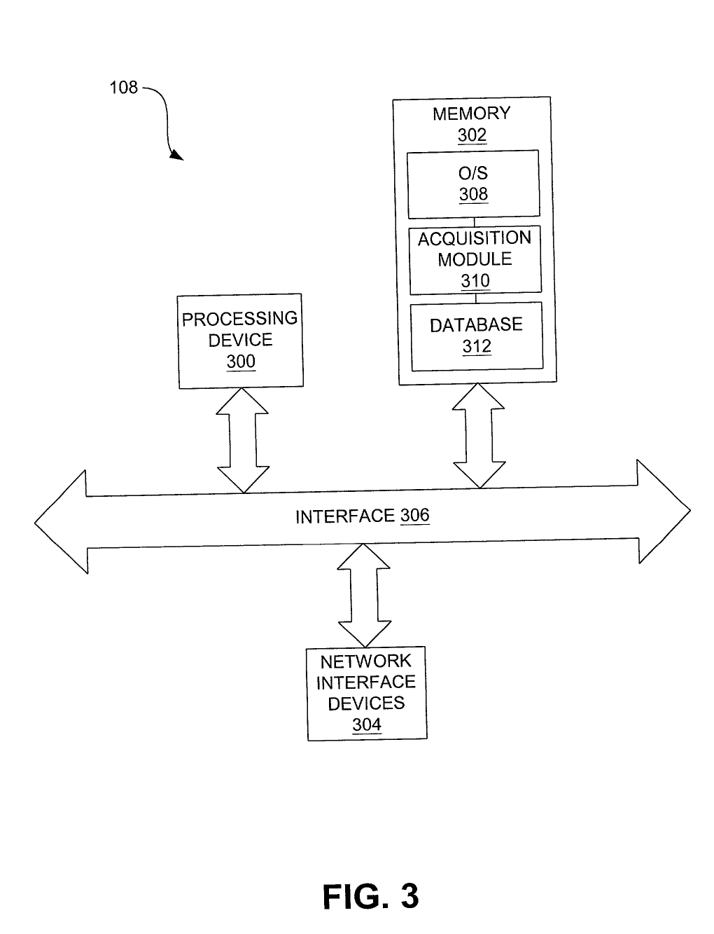

FIG. 3 is a schematic view illustrating an example architecture for the network storage device 108 shown in FIG. 1. As indicated in FIG. 3, the network storage device 108 comprises a processing device 300, memory 302, and network interface devices 304 that are connected to an interface 306 that, by way of example, comprises one or more internal and/or external buses. The interface 306 may have additional elements, which are omitted for simplicity, such as one or more controllers, buffers (caches), drivers, repeaters, and receivers, to enable communications. Furthermore, the interface 306 may include address, control, and/or data connections to enable appropriate communications among the aforementioned components.

The processing device 300 comprises hardware for executing software that is stored in memory 304. The processing device 300 can include any custom made or commercially available processor, a central processing unit (CPU) or an auxiliary processor among several processors associated with the network storage device 108, a semiconductor based microprocessor (in the form of a microchip), or a macroprocessor. The memory 302 can include any one of combination of volatile memory elements (e.g., random access memory (RAM, such as DRAM, SRAM, etc.)) and nonvolatile memory elements (e.g., ROM, hard drive, tape, CDROM, etc.). Moreover, the memory 302 can incorporate electronic, magnetic, optical, and/or other types of storage media. Note that the memory 302 can have a distributed architecture, where various components are situated remote from one another, but accessible by the processing device 300.

As indicated in FIG. 3, the memory 302 comprises various software. In particular, the memory 302 includes an operating system 308, a software acquisition module 310, and a database 312. The operating system 308 controls the execution of other software, such as the acquisition module 310, and provides scheduling, input-output control, file and data management, memory management, and communication control and related services. As described below, the acquisition module 310 is adapted to acquire (e.g., retrieve) software that can be used by the image capture appliance 102 to communicate and control other devices connected to the LAN 110. Once the software is acquired, it can be stored in the database 312 and, where needed, transmitted to the image capture appliance 102 for downloading.

Various software modules have been described herein. It is to be understood that these modules can be stored on any computer readable medium for use by or in connection with any computer related system or method. In the context of this document, a computer readable medium is an electronic, magnetic, optical, or other physical device or means that can contain or store a computer program for use by or in connection with a computer-related system or method. These modules can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the instruction execution system, apparatus, or device.

The computer readable medium can be, for example but not limited to, an electronic, magnetic, optical, electromagnetic, infrared, or semiconductor system, apparatus, device, or propagation medium. More specific examples (a nonexhaustive list) of the computer-readable medium include an electrical connection having one or more wires, a portable computer diskette, a random access memory (RAM), a read-only memory (ROM), an erasable programmable read-only memory (EPROM, EEPROM, or Flash memory), an optical fiber, and a portable compact disc read-only memory (CDROM). Note that the computer-readable medium could even be paper or another suitable medium upon which a program is printed, as the program can be electronically captured, via for instance optical scanning of the paper or other medium, then compiled, interpreted or otherwise processed in a suitable manner if necessary, and then stored in a computer memory.

As described above, it would be desirable for users to be able to use the image capture appliance 102 without having to manually download and configure various software that is needed by the appliance to interact with other devices connected to the LAN 110. Accordingly, the image capture appliance 102 of this disclosure is configured to automatically acquire this software such that user intervention is not needed. By way of example, this software can include executables (e.g., a binary code driver) that are used to communicate with the other devices, and data structures that comprise information pertinent to the particular specifications and configurations of the other devices. The data structures can therefore comprise information such as the resolution of a display of the other device, the number of colors of which the display is capable, etc. With such a configuration, the image capture appliance 102 can automatically adapt itself for use with other devices without the need of user intervention. Additionally, the image capture appliance 102 can evolve such that software updates can be obtained for devices with which the appliance already communicates and for devices new to the market or, at least, new to the LAN 110. It therefore will be appreciated that use of the image capture appliance 102 is greatly simplified.

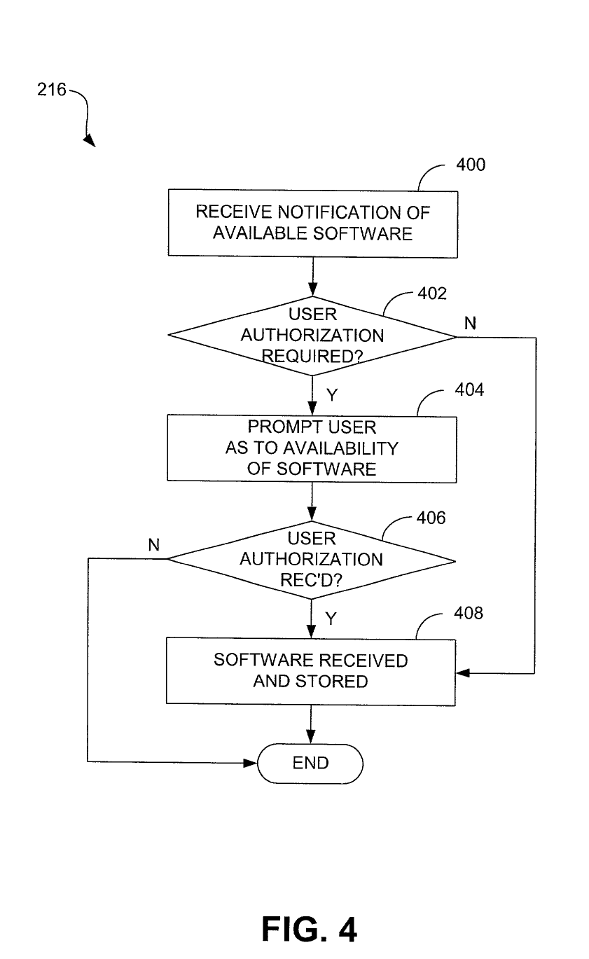

The automated acquisition of software by the image capture appliance 102 can be accomplished in several different ways. FIGS. 4-6 illustrate various example modes of operation of the software acquisition module 216 of the image capture appliance 102. Although several particular modes of operation are described in association with these figures for purposes of example, it will be appreciated by persons having ordinary skill in the art that variations on these modes are feasible and may even be preferable. Furthermore, it is noted that the software acquisition module 216 can be configured to operate in each of the described modes of operation, if desired.

FIG. 4 illustrates a first mode of operation of the software acquisition module 216. In this mode, the image capture appliance 102 receives software (e.g., executables and data structures) in a passive manner from a software source. As indicated in block 400, the software acquisition module 216 first receives notification of software that the image capture appliance 102 can use to interact with other devices connected to the LAN 110. In one arrangement, this notification is received from a web server 114 via the Internet. In such an arrangement, the web server 114 may belong to a vendor that produces the device for which the software is intended. Alternatively, the web server 114 could belong to the manufacturer of the image capture appliance 102.

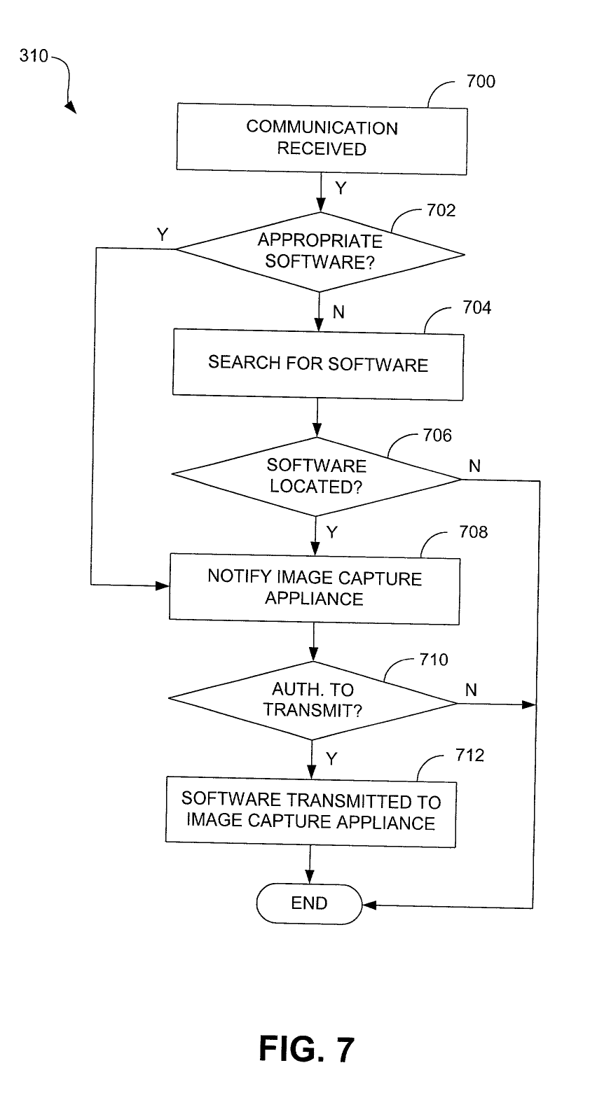

Regardless of which web server 114 communicates to the image capture appliance 102, such communication is normally only possible where the web server has an address for the image capture appliance 102. This address (e.g., universal resource locator (URL)) can be provided to the web server 114 through a registration process that is automatically conducted by the image capture appliance 102 when the appliance is first connected to the LAN 110, and therefore, the WAN 112. Registration can, for instance, be on a vendor-by-vendor basis or can, alternatively or in addition, be with an entity that acts as a repository for this information that can be accessed by substantially any vendor which produces devices that are configured to interact with the image capture appliance 102. In addition to providing an address, identification of the communication software stored on the image capture appliance 102 at the time of registration can further be provided. When this information is provided, the producer of software updates will be able to locate users that could benefit from the updates more easily. In another arrangement, the notification can be received from the network storage device 108. As is discussed below with reference to FIG. 7, the network storage device 108 can acquire software for later transmission to the image capture appliance 102.

Once the notification has been received, it can be determined whether user authorization for downloading the software is required, as indicated in decision element 402. In a preferred arrangement, the user can configure the image capture appliance 102 to either automatically download new software, or, as indicated in block 404, first prompt the user that new software is available and therefore provide the user with the option of accepting or refusing the software. After prompting the user, it is determined whether the user has accepted or refused the software, as indicated in decision element 406. If the user refuses the software, flow is terminated. If, on the other hand, the user accepts the software, the software is, as indicated in block 408, received from the source and it is stored in memory 202 for later use with a device such as a direct-connect device 104 or a computing device 106.

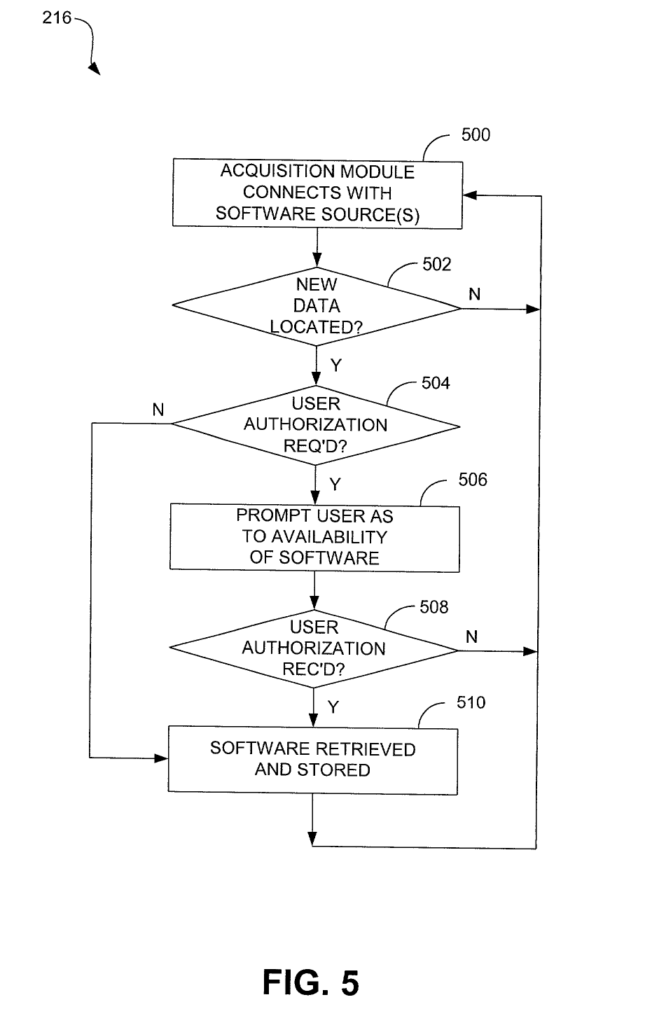

FIG. 5 illustrates a second mode of operation of the software acquisition module 216 in which the acquisition module actively seeks new software. In this mode, the image capture appliance 102 connects with one or more software sources in a search for new software that the image capture appliance 102 can use, as indicated in block 500. By way of example, this connection can be initiated after the expiration of a predetermined length of time (e.g., a week) such that the acquisition module 216 is adapted to periodically check for new software from the software sources. Again, the software sources can comprise a web server 114 connected to the WAN 112, the network storage device 108 connected to the LAN 110, or both. Once the acquisition module 216 has connected with the software sources, it can be determined whether there is new software that the image capture appliance 102 can use, as indicated in decision element 502. The determination can be made according to several criteria. For instance, the software acquisition module 216 can be configured to search for updates for software already possessed by the image capture appliance 102. In such a scenario, software (e.g., a driver) for a particular device can be replaced with a newer version that operates more efficiently and/or with fewer faults. Alternatively or in addition, the acquisition module 216 can be configured to seek software for newly released devices that are specifically intended for use with the image capture appliance. In this manner, the image capture appliance 102 can be pre-configured for use with a device before the user even purchases it.

If new software is not located, flow returns to block 500 and the software acquisition module 216 will reconnect with the software sources at a later time. If new software is located, however, flow continues to decision element 504 where it is determined whether user authorization is first required. If so, the user is prompted as to the availability of the software, as indicated in block 506 and, as indicated in decision element 508, it can be determined whether the user has authorized or refused its download. If authorization is refused, flow again returns to block 500. If authorization is provided, or if authorization was never needed (element 504), flow continues to block 510 and the software is retrieved by the acquisition module 216 and stored in memory 202. At this point, flow can again return to block 500 and the acquisition module 216 can recheck for new software at a later time.

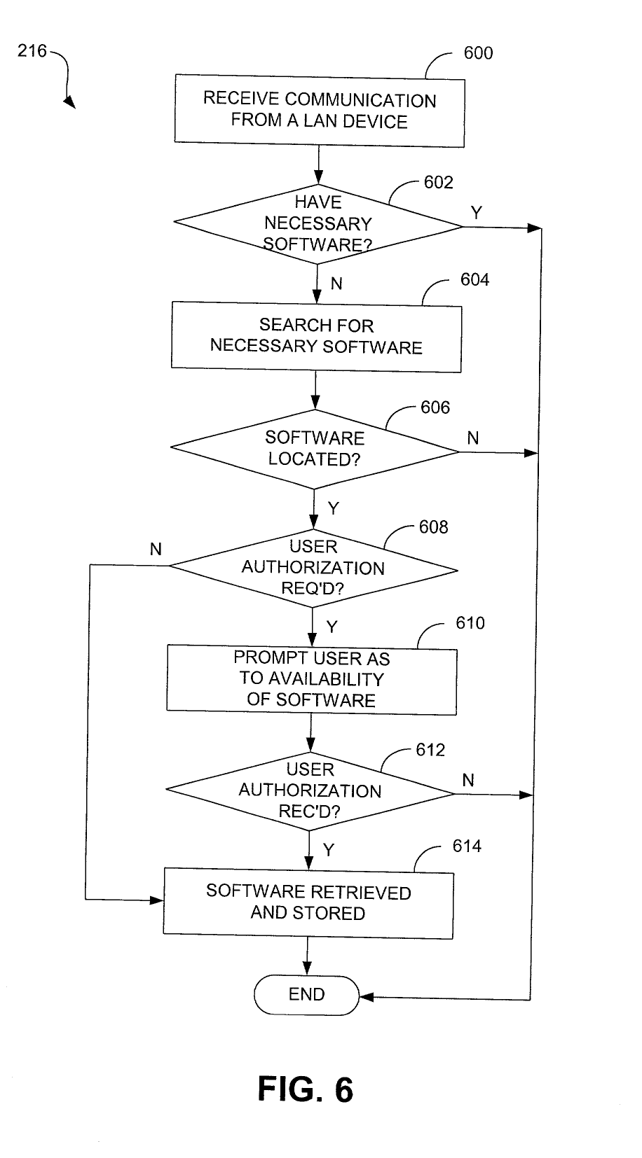

FIG. 6 illustrates a third mode of operation of the software acquisition module 216 in which the acquisition module actively seeks new software in response identification of a device new to the LAN 110. In this mode, the image capture appliance 102 can receive a communication from the device, as indicated in block 600. By way of example, this communication can comprise an initial communication from the device that communicates its presence to the other devices connected to the LAN 110. Therefore, the communication can be transmitted from a direct-connect appliance 104 or a computing device 106 connected to the LAN 110. In an alternative arrangement, the communication can be responsive to a request for identification transmitted by the image capture appliance 102. In either case, the software acquisition module 216 can determine, as indicated in decision element 602, whether the image capture appliance has the necessary software to communicate and/or control the other device. If so, flow is terminated and normal interaction with the device can be attained. Where, however, the necessary software is not stored in the image capture appliance 102, such interaction will not be feasible.

Where the needed software is not possessed by the image capture appliance 102, the software acquisition module 216 searches for software, as indicated in block 604. Again, the software can be obtained from one ore more software sources such as a web server 114 connected to the WAN 112, the network storage device 108 connected to the LAN 110, or both. Through this search, it is determined whether the necessary software has been located, as indicated in decision element 606. If the necessary software is not located, flow is terminated and the user will have to manually locate the software in some manner. If the software is located, it can again be determined whether user authorization is required, as indicated in decision element 608. If so, the user is prompted as to the availability of the software, as indicated in block 610, and it can be determined whether the user has authorized or refused its download, as indicated in decision element 612. If authorization is refused, flow is terminated and interaction between the image capture appliance 102 and the other device will not be feasible. If authorization is provided, however, or if authorization was never needed (element 608), flow continues to block 614 and the software is retrieved and stored.

As mentioned above, the network storage device 108 can serve as a software source for the image capture appliance 102. Therefore, the network storage device 108 can serve as a local repository for software that can be used by the image capture device 102 to communicate and/or control other devices connected to the LAN 110. In such a scenario, the network storage device 108 typically is provided with a software package that comprises executables and data structures for many different devices that are intended for use with the image capture appliance 102. As noted above, this software can be stored in the database 312. In addition, however, the network storage device 108 can, like the image capture appliance 102, also receive software from another source, such as a web server 114. Furthermore, the network storage device 108 can be configured so as to actively search for software in response to a request from the image capture appliance 102, as is explained below with reference to FIG. 7.

FIG. 7 illustrates operation of the software acquisition module 310 of the network storage device 108. As indicated in block 700, the acquisition module 310 first receives a communication. This communication can comprise a notification from a web server 114 that new software is available. Alternatively, the communication can comprise a request from the image capture device 102 for software it needs to interact with another device. In either case, the acquisition module 310 can determine if it has the software offered or needed as indicated in decision element 702. If so, flow continues to block 708 at which the network storage device 108 notifies the image capture appliance 102 of this software. At this point, the acquisition module 310 can determine whether it is authorized to transmit the software to the image capture device 102, as indicated in decision element 710. If authorization is provided, the acquisition module 310 transmits the software to the image capture appliance 102, as indicated in block 712, and flow is terminated.

With reference back to decision element 702, if the software is not possessed by the network storage device 108, the software acquisition module 310 will conduct a search for the software, as indicated in block 704 in similar manner to that described above in relation to the image capture appliance 102. Once the needed software is located (element 706), notification can again be delivered to the image capture appliance 102, as indicated in block 708 and, if authorization is provided, the software can ultimately be transmitted to the image capture appliance for download, as indicated in block 712.

What is claimed is:

1. An appliance configured for connection to a network and communication with a device connected to the network, the appliance comprising:
a processing device configured to control operation of the appliance;
memory including logic configured to receive software that facilitates communication between the appliance and the device from a software source; and
a network interface device with which the appliance communicates with the software source.

2. The appliance of claim 1, wherein the logic configured to receive software is adapted to transmit approval to the software source in response to a notification from the software source of the availability of the software.

3. The appliance of claim 1, wherein the logic configured to receive software is adapted to transmit approval only upon authorization received by a user of the appliance.

4. The appliance of claim 1, further comprising logic configured to actively retrieve software from the software source.

5. The appliance of claim 4, wherein the logic configured to actively retrieve software is adapted to periodically search for software for the appliance.

6. The appliance of claim 4, wherein the logic configured to actively retrieve software is adapted to search for software for the appliance in response to a communication from the software source.

7. The appliance of claim 1, wherein the logic configured to receive software is adapted to receive executables and data structures for accessing the device.

8. The appliance of claim 1, wherein the appliance is an image capture appliance.

9. An appliance configured for direct connection to a network and communication with a device connected to the network, the appliance comprising:
a processing device configured to control operation of the appliance;
an acquisition module adopted to receive software that facilitates communication between the appliance and the device from a software source; and
network interface devices with which the appliance communicates with the software source.

10. The appliance of claim 9, wherein the means for receiving software are adapted to transmit approval to the software source in response to a notification from the software source of the availability of the software.

11. The appliance of claim 9, further comprising means for actively retrieving software from the software source.

12. The appliance of claim 11, wherein the means for actively retrieving software are adapted to periodically search for software for the appliance.

13. The appliance of claim 11, wherein the means for actively retrieving software are adapted to search for software for the appliance in response to a communication from the software source.

14. The appliance of claim 1, wherein the appliance is an image capture appliance.

15. A network storage device, comprising:
a processing device configured to control operation of the device;
memory including logic configured to receive software that facilitates communication between a network appliance and a separate network device, and including logic configured to transmit software to the network appliance; and
a network interface device with which the network storage device communicates with the network appliance.

16. A method for enabling communications between an appliance and a separate device, comprising the steps of:
automatically receiving software with the appliance that facilitates communication between the appliance and the separate device; and
storing the software in memory of the appliance such that the appliance is adapted to communicate with the separate device.

17. The method of claim 16, further comprising the step of receiving a notification from a source of software with the appliance regarding the availability of the software prior to receiving the software.

18. The method of claim 16, further comprising the step of automatically searching for software over a network to which the appliance is connected.

19. The method of claim 18, wherein the step of automatically searching is conducted on a periodic basis.

20. The method of claim 18, wherein the step of automatically searching is conducted in response to a communication from the separate device.
